(19) United States
(12) Patent Application Publication
(10) Pub. No.: US 2023/0011404 A1
(43) Pub. Date: Jan. 12, 2023

(54) Household Appliance with Multifunctional Display

(71) Applicant: Vorwerk & Co. Interholding GmbH, Wuppertal (DE)

(72) Inventors: Torsten Lang, Solingen (DE); Felix Haunschild, Essen (DE); Dietmar Mehlhase, Köln (DE)

(21) Appl. No.: 17/858,272

(22) Filed: Jul. 6, 2022

(30) Foreign Application Priority Data
Jul. 6, 2021 (EP) 21 183 992.3

(51) Int. Cl. H04N 13/366; G06F 3/16; H04N 13/356; H04N 13/302

(52) U.S. Cl. CPC H04N 13/366; G06F 3/167; H04N 13/356; H04N 13/302

(57) ABSTRACT

The invention relates to a household appliance (100), in particular a kitchen appliance (100) for preparing food, comprising a processing device (110) for at least partially automatically carrying out a household activity, in particular for processing ingredients, wherein the processing device (110) is controlled by a control unit (102). Further, the household appliance (100) comprises a position device (120) for detecting position information (200) of a user (1) operating the household appliance (100), the position information (200) being transmitted to the control unit (102). Furthermore, the household appliance (100) has a display (130) which is adapted to reproduce image information (140) determined by the control unit (102), wherein the image information (140) reproduced by the display (130) generates an impression of depth at the user (1) and is dependent on at least the position information (200) of the user (1). Furthermore, the invention relates to a method for operating a household appliance (100).

The invention relates to a household appliance and a method of operating a household appliance.

Household appliances are known from the prior art, the operation of which becomes increasingly complex with advancing development. Therefore, many household appliances known from the prior art use a variety of display information, displays and control elements with which, on the one hand, the user can be informed about the status of the household appliance and, on the other hand, can control the various functions of the household appliance.

Despite the use of several displays or several control elements, a user may be overwhelmed by the operation of the household appliance. In particular, if the user has to perform a complex sequence of steps on the household appliance, it can easily happen that the user loses the overview.

In addition, it can be difficult to guide the user easily and clearly with the aid of familiar displays in the case of processes that require the user's spatial awareness. This can have the consequence that the sequence intended by the household appliance is not carried out or is not carried out correctly, so that the result of the household activity which is to be carried out with the household appliance is not achieved or is defective.

It is an object of the present invention to at least partially overcome the foregoing disadvantages known from the prior art. In particular, it is a task of the present invention to provide a household appliance as well as a method for operating a household appliance which facilitates the at least partially automatic execution of a household activity for the user in order to reliably ensure an improved result of the household activity.

The foregoing object is solved by a household appliance, and by a method as described here. Further features and details of the invention are described in the claims, the description and the drawings. Features and details which are described in connection with the household appliance according to the invention naturally also apply in connection with the method according to the invention and vice versa in each case, so that with regard to the disclosure concerning the individual aspects of the invention reference is or can always be made mutually.

According to a first aspect of the invention, a household appliance, in particular a kitchen appliance for preparing food, is provided. In this respect, the household appliance comprises a processing device for at least partially automatically carrying out a household activity, in particular for processing ingredients, the processing device being controlled by a control unit. Further, the household appliance comprises a position device for detecting position information of a user operating the household appliance, the position information being transmitted to the control unit. Furthermore, the household appliance has a display which is designed/configured to reproduce image information determined by the control unit, in particular for controlling and/or operating the household appliance, the image information reproduced by the display generating a (preferably three-dimensional) depth impression at the user and being dependent on at least the position information of the user. Thereby, at least the processing device, the control unit, the position device as well as the display can exchange at least the required control, image and position information as (bidirectional) data.

A household appliance within the meaning of the present application is any electromechanical and/or electrical appliance which is normally used for household purposes. This includes in particular vacuum cleaners, kitchen appliances (white goods), as well as washing machines and dryers. Also, so-called kitchen appliances for the preparation of meals, beverages or intermediate products thereof are understood as household appliances in the sense of the application. The household appliance can be at least partly stationary. In this context, semi-stationary can mean that it has a fixed installation site at least for the execution of the household activity and/or has a mains connection via which the household appliance is supplied with energy.

The household activity can be a mechanical-physical activity, which is supported by the household appliance, for example vacuuming, washing up or the at least semi-automatic processing of ingredients according to a recipe (with the necessary work steps, such as cooking, stirring, chopping, weighing etc.).). For example, it may also be a matter of displaying information, for example displaying a shopping list, displaying a recipe, in particular with the required work steps/stages, and/or also receiving commands, for example setting a timer, switching on a stirrer, operating a heater, etc.

The processing device is suitable for performing a household activity, in particular vacuuming, washing, cooking, dishwashing, at least partially automatically, or for supporting the at least partially automatic performance of the household activity. In a kitchen processor, the processing device may comprise, for example: a stirrer, a cutting blade, an electric motor for driving the stirrer or an attachment, a stirring vessel, a heater for heating the stirring vessel or the ingredients therein, and a processor for coordinating the functions of said components. The processing device may in particular comprise a drive, for example an electric motor. This can, for example, drive the fan of a vacuum cleaner or the stirrer of a kitchen appliance whereby in each case the fan or the stirrer can also be regarded as a processing device or as part thereof.

The positioning device is suitable for determining a position information of a user or a person operating the household appliance. On the one hand, this can be done passively, for example by a user input of the user at the positioning device and/or by a recognition of a user profile from the user. For this purpose, an input interface, in particular designed/configured as a rotary knob and/or as a touch screen of the display, may be provided. On the other hand, or in addition thereto, it may also be provided that the positioning device detects the position information actively and without any action on the part of the user, for example by means of a sensor that detects the position of the user, in particular the head and/or the eyes of the user.

The positioning device may also be adapted to accept further input from the user relating to the control of the household appliance, such as the selection of a recipe, the switching on and off of the household appliance, etc. It may be provided that a user profile is stored or created for the first time for the user in the household appliance, in particular in the control unit and/or on a non-volatile storage medium. The user profile may comprise the body height of the user.

Furthermore, the user profile may also comprise an instruction or information, in particular for the control unit, whether for the user profile the image information is to be rendered in a 2D mode or in a 3D mode. This further simplifies the handling of the household appliance, in particular the user thus has to make fewer inputs.

Position information may be, for example, the distance of the user to the household appliance and/or the height of the user. It may also be provided that the position information indicates the position of at least one eye or both eyes of the user in space or with respect to the household appliance. The position information may be absolute with respect to fixed coordinate systems (for example, as GPS coordinates, possibly plus an altitude above sea level) and/or with respect to the household appliance itself. In particular, with respect to the household appliance or the display, position information may be given, for example, as distance R, azimuth angle cp, and height Z with respect to the household appliance or its display as coordinate origin.

It is also conceivable that instead of a (concrete) position information of the user, a generally valid position information is also used for the reproducing image information by the display. Thus, it is also possible that several users can simultaneously recognize the reproduced (displayed) image information (respectively) with an impression of depth.

The control unit can be, for example, a central processing unit (CPU), a graphical processing unit (GPU), a microcontroller, an integrated circuit (IC), in particular a field programmable gate array (FPGA), or a combination thereof, which are suitable for acquiring, storing and/or processing signals and for outputting commands. In particular, the control unit, especially the graphical computing unit, may be designed/configured to be able to execute processes in parallel in order to increase computing power and enable particularly user-friendly operation. It can also be provided that the control unit at least partially delivers or exchanges the data to an external control unit to which the control unit is connected in particular via the Internet or WLAN.

The display is suitable for creating an impression of depth in the user during the reproduction of image information. In this context, depth impression means that the user receives a spatial impression of the displayed information that corresponds to how it would be if he actually saw the displayed information at a given distance. Thus, it is not merely a two-dimensional projection of a three-dimensional object. Rather, the image information reproduced by the display is capable of creating in the user the impression of a true three-dimensional image as he would perceive it if the displayed objects were actually in front of him. It may be provided that the image information comprises at least a foreground and a background, which are spatially separated from each other, i.e. have a distance to each other. It may be provided that the display has a touch function, preferably for inputting control information. In other words, the display may be designed/configured in such a way that it can detect an input from the user, in particular by capacitive sensors, and forward it to the control unit. This allows the kitchen appliance to be controlled particularly easily and also intuitively for the user.

It is possible that the positioning device and, if applicable, the control unit are at least partially integrated into the display. Individual components of the positioning device or the positioning device as a whole may be integrated in a recess in the display (notch) or completely invisibly in the display. It can also be provided that the positioning device is integrated in a frame of the display. Also, a part of the control unit may be integrated in the display, in particular to perform the communication for control between the positioning device and the display. For the user, the compact design/configuration offers the advantage that he is not irritated by the positioning device, thus facilitating operation.

The image information can be composed of an image content, and distance information, which specifies the distance at which individual image objects of the image content are to be displayed from each other or from the user. For example, the image information may comprise a pictorial representation of a tomato (image content) located at a distance of 100 cm from the user (distance information). In particular, the image information may be expected cooking results or recipe results or work steps. This offers the advantage that the user can easily recognize (on the basis of the spatial representation) which result the recipe steps (work steps of a recipe) executed by him (one after the other in time) will have. Here, it is conceivable that the respective recipe steps are presented (in order) on a spatial time axis by the display for the user. The information underlying the image information can be, in particular, metadata in recipes, links in recipes to images, graphical representations, an image-based recipe structure, in particular with rendered images, and/or a virtual tour through a cooking process, in which, in particular, recipe step-dependent 3D representations of the ingredients are stored with stored 3D instructions for processing. The corresponding data may be stored on the household appliance itself on a memory or stored in a cloud memory that the household appliance can access via an Internet connection. When displaying the image information, it may further be provided that the display of the distance information and/or the size information scales with the amount of an ingredient. It may also be provided that the image information comprises recipe instructions that show the user instructions for action, in particular for processing ingredients, in a 3D representation. In particular, it may be provided that the ingredient currently to be processed and/or the processing currently to be applied are shown. It can also be provided that future processing and/or processing steps/stages and/or ingredients are shown, whereby these differ from the respective current processing, the current processing step/stage or the current ingredient in their representation, in particular by the size of the representation and/or the represented depth. In particular, it can be provided that the closer a future processing and/or a future processing step/stage and/or a future ingredient is to the current processing and/or the processing step/stage and/or the ingredients, these are represented by the display increasingly larger and/or increasingly closer.

Furthermore, it can be provided that the image information comprises the display of positions of ingredients in the kitchen, whereby the user is presented with a 3-D image of his kitchen environment. For this purpose, it can be provided that the user transmits an image to the household appliance in advance. This enables the user to detect the position of ingredients to be processed particularly quickly and easily, so that the operation of the household appliance is simplified.

The household appliance according to the invention offers the advantage that information presented by the display of the household appliance in the form of image information can be easily grasped by the user and, for example, the status of a household appliance can be particularly well understood by the user. Instructions to the user also become easier for the user to understand. The user is thus supported overall in the operation of the household appliance, so that it is easier for him to use it and the desired result of the household activity can be achieved intuitively. In particular, if the household appliance is a kitchen appliance, use can be simplified for the user, which in particular ensures that the cooking result can be reliably achieved satisfactorily.

Preferably, in a household appliance according to the invention, it can be provided that the display has an autostereoscopic display and/or virtual reality glasses and/or a holographic display. By an autostereoscopic display is meant a display which creates an impression of depth for the user without the need for further aids on the part of the user, for example in the form of glasses or a “head-mounted display”. For this purpose, the user's eyes are each presented with their own image, which generates a three-dimensional image impression through processing in the user's brain. This offers in particular the advantage that the user does not require any further aids for the use of the household appliance, which additionally simplifies the operation of the household appliance. It may also be provided that the display comprises special glasses, virtual reality glasses or a head-mounted display. Such glasses usually have at least two displays, each of which shows images that differ from one another, wherein the displays can be arranged in front of the user's eyes in such a way that the user can only see one display or the image information shown on it with one eye at a time. This also creates an impression of depth when viewed by the user. These glasses offer the advantage that a particularly good immersion of the user is achieved, so that the user can operate the household appliance particularly easily. In the case of a holographic display, light diffraction in particular is used to create a virtual three-dimensional image or an impression of depth for the user. Holographic displays also offer the advantage that no special glasses or other aids are required to create the impression of depth in the user.

Furthermore, in a household appliance according to the invention, it is conceivable that the display comprises at least one of the following components: an optical component, in particular a lens array, a barrier-mask, or a light-emitting unit. In other words, it can be provided that the light emitted by the display is refracted, diffracted, absorbed, (re)emitted, or otherwise physically influenced by an optical element, for example a lens, a filter, or a grating, in particular to create the impression of depth of the image information reproduced by the display for the user. In this context, the provision of optical components offers the advantage that they enable a compact design/configuration of the household appliance and do not require any further aids from the user, so that the operation of the household appliance is simplified for the user. In the case of a lens array, it can be provided that the lens array has a plurality of lenses, in particular cylindrical lenses, which are suitable for providing the user in each case with reproduced image information for the left eye and image information for the right eye, whereby an impression of depth can be produced for the user. For this purpose, a light unit may be provided which, starting from the eye of the viewer, is located behind the lens array and reproduces the image information by emitting photons, the photons emitted by the light unit being deflected by the lens array, in particular by refraction, so that the right and left eyes of the viewer each perceive different image information. Furthermore, it can be provided that a barrier mask is designed/configured so that different image information arrives at the user for the right and left eye in each case, thus creating the depth impression. For this purpose, it can be provided that a light unit, starting from the eye of the viewer, is located behind the barrier mask and reproduces the image information by emitting photons, the photons emitted by the light unit being partially blocked by the barrier mask so that the right and left eyes of the viewer perceive different image information. In particular, the light emitting unit may be a liquid crystal display illuminated by Light Emitting Diodes (LEDs) and/or Organic Light Emitting Diodes (OLEDs).

The use of LEDs offers the advantage that they can emit a lot of light even at low power consumption, so that the displayed information is easily recognizable for the user even at lower power consumption. The use of OLEDs offers the advantage that they have a particularly high contrast, so that the reproduced image information is easily recognizable for the user. Liquid crystal displays of the twisted nematic (TN), vertical alignment (PVA/MVA) and in-plane switching (IPS) types are particularly suitable for liquid crystal displays. The use of TN panels offers the advantage that they are particularly responsive, which means that fast motion sequences are easily recognizable by the user, so that the displayed image information can be easily absorbed. The use of PVA panels offers the advantage that they have a high contrast and at the same time function relatively independent of the viewing angle, so that the user can easily absorb the displayed image information. IPS panels also offer the advantage of wide viewing angles, while also having high color fidelity so that the user can easily absorb the reproduced image information and easily operate the household appliance.

Within the scope of the invention, it is further conceivable that the image information reproduced by the display generates an impression of depth at the user at a defined image position in relation to the display, wherein the defined image position corresponds to the position information of the user and, in particular, can be adapted to the defined image position when a user moves in relation to the display. In other words, it can be provided that the image information which is reproduced by the display can generate the depth impression at the user at a defined position at which the user is located. Thereby, the position information may correspond exactly to the defined image position, so that when the position information corresponds to the position of the user, the depth impression can be aroused in the user. For example, the position information may be defined in terms of a distance from the display as well as an azimuth angle with respect to the display or a normal to the display and a height from the display. Typically, a user moves at least minimally when using or approaching the household appliance for use. Accordingly, it may be advantageously provided that the defined image position adjusts according to the user's position information so that the user receives an impression of depth when viewing the image information at any time the user is using or approaching the household appliance. In other words, it may be provided that the image position tracks the position of the user. This achieves the advantage that the user can easily perceive the displayed image information at any point in time and thus better operate the household appliance.

Furthermore, in a household appliance according to the invention, it is conceivable that the positioning device is suitable for detecting position information for a plurality of users in each case, and/or that the display is suitable for reproducing a plurality of items of image information which each generate an impression of depth for a plurality of users. Accordingly, it can be provided in the case of the positioning device that the latter can also locate a plurality of users individually in each case and can determine a position information for one user in each case. For this purpose, it can be provided, for example, that a sensor, in particular a camera, is provided for detecting a plurality of users and separating them from one another so that the position information for individual users can be determined. Alternatively, or in addition thereto, it may be provided, in other words, that if a plurality of users is in the vicinity of the household appliance, each user is displayed adapted image information, which creates an impression of depth for each user individually. For this purpose, it may be provided that the display generates two images for each user, the two images each reaching a right or a left eye of the respective user and thus generating an impression of depth. In particular, it can be provided that the control unit generates the two images in real time according to the position information. This further improves the user experience.

Within the scope of the invention, it is further conceivable that the display comprises a 2D mode and a 3D mode, wherein in particular the display switches between the 2D mode and a 3D mode based on the position information. In other words, it may be envisaged that the display may also revert to a mode in which no depth impression is generated for the user. Nevertheless, three-dimensional objects can also be displayed to the user in a 2-D mode, but then as a projection onto a two-dimensional space. In particular, it can be provided that if the control unit detects, based on the position information determined by the position device, that no depth impression can be generated by the display at the position of the user according to the position information, the display switches from 3-D mode to 2-D mode, or the display switches from 2-D mode to 3-D mode as soon as the control unit detects that a depth impression can be generated (again) by the display at a position of the user according to the position information. However, it can also be provided that the user can switch between the 2-D mode and the 3-D mode independently by an input, in particular at the position device.

Furthermore, it is conceivable in a household appliance according to the invention that a user identification device is further provided which is designed/configured to identify the user, the user identification device being designed/configured in particular to communicate with a mobile identification transmitter of the user. Alternatively, or in addition, it is conceivable in a household appliance according to the invention that a user identification device is further provided which is adapted to actively and/or passively identify the user, wherein in particular the image information reproduced by the display is specific to the identified user. In other words, a device can be provided on the household appliance which is capable of recognizing the identity of a user. This offers the advantage for the user that the image information can be adapted in a personalized manner for the recognized user, so that the operation of the household appliance is further simplified for the user. In this context, the user can, for example, log on to the user recognition device at the household appliance himself. However, it can also be provided that the user carries a mobile identification transmitter with him, by which the user recognition device recognizes which user is in the vicinity of the household appliance. The mobile identification transmitter may be, for example, a mobile radio device and/or an RFID tag, in particular a personalized RFID tag. It may be provided that the mobile identification transmitter communicates wirelessly, in particular via Bluetooth (BT), Bluetooth low energy (BTLE) or Wireless Local Area Network (WLAN), with the user recognition device. This offers the advantage that the identity of the user can be established particularly easily and that the user, without having to provide his user data to the user identification device itself, can have personalized information and image information tailored to him displayed, in particular with respect to the size of the user. This offers the advantage for the user that the handling of the household appliance is further simplified. It may also be provided that the user identification device is adapted to transmit and/or receive ultra-wideband (UWB) signals and to determine the position of the user and/or the mobile identification device by means of the UWB, in particular in communication with the mobile identification device, which may also be adapted to transmit and/or receive UWB. This offers the advantage that the position of the user and/or the mobile identification transmitter can be detected with particular certainty.

It is further conceivable in a household appliance according to the invention that the display, in particular on a housing of the display, has at least one axis of rotation, in particular two axes of rotation, about which the display can be rotated in relation to the user, in particular based on the position information. In other words, it may be provided that the display can be rotatably mounted, in particular about two axes of rotation, with respect to the user or the user's face. This offers the advantage that the image information reproduced by the display can be adapted according to the position of the user in such a way that an impression of depth can be created in a particularly wide range of possible positions of the user. For example, if the household appliance is a washing machine, depth impression image information can be displayed to the user both when the user is standing in front of the washing machine, for example to select the washing program, and when the user is loading the washing machine and is in a crouched position for this purpose. For example, if the household appliance is a kitchen appliance, the user may be shown depth impression generating image information both when the user is directly in front of the kitchen appliance and when the user is next to the kitchen appliance, for example, to prepare ingredients for cooking in the kitchen appliance (for example, washing in the sink). It may be provided that the display is gimbaled. This offers the advantage that, in particular when the household appliance is moving, the display can be aligned in relation to the user's face independently of the movement of the household appliance, so that even when the household appliance is moving, it remains possible to display image information to the user which creates an impression of depth in the user.

Furthermore, it is conceivable in a household appliance according to the invention that a further display is provided, which is designed/configured in particular as a 2D display. In other words, the household appliance can have at least one further display which is designed/configured in particular without a 3-D function. This offers the advantage that information which is not given any added value by a three-dimensional display mode can also be displayed to the user independently of the display, so that operation of the household appliance is simplified for the user. In particular, it can be provided that the user is shown information on the status of the display on the further display, for example in which direction the display must be rotated so that the reproduced image information can create an impression of depth for the user. It may be provided that the direction in which the display must be rotated is derived from the user's user profile. This offers the advantage that the user can position himself optimally so that the image information creates an impression of depth.

It is further conceivable in a household appliance according to the invention that the positioning device comprises at least one of the following components:
a manually operable input unit, in particular a rotary knob, which is designed/configured in particular to control at least the processing device by an input from the user,
a camera, which is especially designed/configured to capture the user,
a gesture sensor adapted to detect a gesture of the user for controlling the household appliance, or
a sound transducer which is designed/configured to detect a voice input of the user for controlling the household appliance, the sound transducer being designed/configured in particular as a microphone.

It can also be provided that the position and/or the size of the user are derived from a user profile. Furthermore, control parameters for the positioning device and/or the control unit can be used from a user profile and serve as a basis for adapting the image information in particular to a size of the user and/or a distance of the user from the display. The manually operable input unit, which can be designed/configured in particular as a rotary knob, offers the advantage that the user can operate the household appliance even if, for example, the positioning device and/or the display is not currently visible to him. If, for example, the user is positioned to the side of the household appliance so that, for example, he can reach the manually operable input unit with his arm but cannot see the display, he can nevertheless start or stop the function of the household appliance, for example, by making an input at the positioning device. In this context, the design/configuration as a rotary knob offers the advantage that it provides particularly good haptic feedback for the user and is therefore particularly easy to operate. The manually operable input unit can be designed/configured in such a way that the user can make the input (exclusively) on the display. In particular, the manually operable input unit can be designed/configured as a touch display. This offers the advantage that operation is made easier for the user, since he is already accustomed to operable displays and these are furthermore easy to clean (due to the smooth surface). Via the manually operable input unit, the user can, for example, enter his size or identity so that the control unit can adjust the reproduced image information by the display so that the depth impression is adapted and optimized to the position information specified by the size or identity.

The camera offers the advantage that the positioning device can detect one or more users particularly easily. In particular, it can be provided that the camera additionally has an illumination unit, which emits infrared light in particular, in order to illuminate the users located in the vicinity of the positioning device. This can improve the image quality of the camera and facilitate the determination of the position information of the users. The use of an infrared light source offers the advantage that it is invisible to the users, and thus the users are not irritated when using the household appliance, which further simplifies the use of the household appliance. Likewise, it may be provided that the camera is suitable for performing a time-of-flight analysis, whereby in particular the distance of the user can be determined. It may be provided that the camera detects the eyes of the user, in particular continuously. In doing so, the camera can transmit the position of the eyes as position information to the control unit, which adjusts the image information displayed by the display accordingly and, in particular, tracks the current position and/or viewing direction of the user accordingly. In this way, the depth impression can be generated for the user even if the user is moving.

A gesture sensor, which is designed/configured to detect a gesture of the user to control the household appliance, offers the advantage that the user does not have to come into contact with the household appliance to operate it. In particular, if the household appliance is a kitchen appliance, this can be advantageous as the user may have dirty hands when preparing food, which they then do not need to use to touch the kitchen appliance. This also offers the advantage of simplifying the use of the household appliance.

A sound transducer (for a voice recognition system), which is designed/configured to detect a voice input of the user for controlling the household appliance, offers the advantage that here too the user does not have to come into contact with the household appliance when operating it. In this case, the sound transducer can be formed in particular as a microphone. This represents a particularly simple and inexpensive form of sound transducer. It can also be provided that the sound transducer or the microphone has/have a directional characteristic so that, in particular, voice input of the user for controlling the household appliance can be detected from positional information of the user. This offers the advantage that the user's voice input and not, for example, ambient noise is particularly reliably detected, which simplifies the use of the household appliance. Thus, the household appliance may also include a voice recognition system for control, further simplifying operation for the user.

Furthermore, in a household appliance according to the invention, it may advantageously be provided that the gesture sensor comprises at least one of the following components:
a camera,
a radar sensor,
a lidar sensor,
a capacitive sensor or
an ultrasonic sensor.

A camera on the gesture sensor offers the advantage that gestures by the user can be detected particularly easily. In particular, an additional advantage is achieved if the position device can use the same camera to determine the position information, since components can thus be saved.

A radar sensor and a lidar sensor offer the advantage that the position of the user's gesturing body part, for example a hand or a foot, can be detected particularly reliably and a movement of the body part can also be tracked particularly quickly and reliably. This means that gestures can be detected particularly reliably, so that operability for the user is increased.

A capacitive sensor offers the advantage that it can be manufactured particularly inexpensively and at the same time can reliably detect the approach of a part of a user's body, thus enabling particularly easy operation by the user.

In the case of an ultrasonic sensor, the propagation time of a signal emitted by the ultrasonic sensor and reflected by the element to be detected can be measured in particular, whereby a distance of the element to be detected can result from the propagation time difference between the emitted and the reflected signal. If the gesture sensor comprises an ultrasonic sensor, this offers the advantage that the position of the user or a part of the user's body can be detected particularly reliably, which increases operability.

It can be provided that several components are provided for detecting a gesture of the user, wherein in particular the data determined therefrom can be compared with each other by the control unit in order to detect a gesture of the user particularly reliably.

It is further conceivable in a household appliance according to the invention that the household appliance is of multi-part design/configuration and has at least one main body which can be connected to a mains power supply and/or on which the processing device is provided, wherein in particular the display is detachably attached to the main body or the display is integrally connected to the main body. In other words, the household appliance may have a multi-member or modular structure, wherein in particular the individual components are connectable to each other or are at least partially integrally connected to each other. If the household appliance is designed/configured as a kitchen appliance, it may be provided, for example, that a main body is provided, which remains at least partially stationary, and a plurality of parts, in particular a mixing bowl, are provided, which are detachable from and (re)connectable to the main body. It may be provided that the main body comprises in particular the processing device, the positioning device, the display and/or the control unit. A display detachably attached to the main body offers the advantage that the display can be removed from the main body and moved by the user to a position where the display can reproduce the image information in such a way that an impression of depth is created for the user. This is particularly advantageous if the user has to move around when using the household appliance.

According to another aspect of the invention, a method of operating a household appliance, in particular a kitchen appliance for preparing food, comprising the following steps/stages:
Detection of position information of a user by a position device,
Reproduction of image information by a display which is designed/configured to generate an impression of depth for the user, the image information being dependent on at least the position information.

Thereby, the image information through the display can serve for simplified control of the household appliance by the user.

In other words, in the method according to the invention, position information is detected by the user through the positioning device, and image information is reproduced by the display at the detected position information, whereby the image information reproduced by the display creates an impression of depth for the user. The user thus has the possibility of perceiving the image information three-dimensionally, so that operation of the household appliance is simplified hereby. It may be provided that the position information is transmitted to a control unit, and/or that this control unit determines the image information which is reproduced by the display. It may be provided that the acquisition of the position information is continuous. This offers the advantage that the image information of a position of the user can generate an impression of depth even when the user is moving, so that the position information changes over time. It can also be provided that the acquisition of the position information takes place at specific time intervals, with time intervals being designed/configured in particular to be greater than a frame repetition frequency of the display. This offers the advantage that the computing power required to determine the position information can be reduced.

Thus, a method according to the invention brings the same advantages as have already been described in detail with reference to a household appliance according to the invention.

Further, in a method according to the invention, it may advantageously be provided that the method further comprises at least one of the following steps/stages:
Reproduction of image information specific to the operation of the household appliance by a display, wherein in addition to the image information, previous image information and/or subsequent image information is displayed, wherein in particular at least two of the image information differ in a depth of representation for the user,
Initial recognition of a user by a user identifier, switching the display to a 2D mode especially in case of a recognition failure,
Detection of a gesture of the user by a gesture sensor to control the household appliance, and/or detection of a voice input of the user to control the household appliance by a sound transducer,
Performing a household activity, in particular the at least partially automatic preparation of food, in particular controlled by the control unit, in particular according to the at least one detected gesture of the user.

The reproduction of the image information offers the advantage that the user obtains a (also) spatial idea of the household activity, so that the operation of the household appliance is thereby facilitated for the user. In particular, the representation of processes running one after the other in time can be illustrated more easily for the user. The image information can show sequence information of a process of a household activity, in particular individual steps of a recipe. For this purpose, it is particularly helpful if at least two of the image information items differ in a display depth for the user, in other words, if one image information item is displayed further away from the user than a previous or subsequent image information item. It can be provided that the individual image information is spatially displayed on a cuboid, in particular as on a kind of CD cover, and that this image information moves in a three-dimensional space represented by the display in the course of processing the household activity. In the case of an initial recognition of the user by the user identification device, it is ensured that the image information is optimized in such a way that, in the case of the user, the image information reproduced by the display can reliably generate an impression of depth. If the user identification device fails, in other words, if a user cannot be uniquely assigned, the display can be operated in a 2-D mode. This offers the advantage that even a user who is not yet known to the household appliance can safely operate the household appliance, for example, to enter his or her user ID. The detection of a gesture of the user by the gesture sensor offers the advantage that the user does not have to touch the household appliance or the positioning device with his hands to control the household appliance, which simplifies the overall use of the household appliance.

It may be provided that the body part detected by the gesture sensor is reproduced as a 3-D user object in the image information. In particular, it can be provided that a hand of the user is reproduced as a 3-D user object in the image information. This offers the advantage that the user can also find the gesture taking place in three-dimensional space represented spatially in the image information, so that the use of the household appliance is simplified.

It can also be provided that at least one 3-D object is displayed which corresponds to an, in particular analog, input object, in particular a rotary control. It may be provided that the user can control the input object by a gesture, and the 3-D object is adapted according to the user's input. For example, the user can rotate a rotary control represented as a 3-D object by a gesture. It may also be provided that the user controls the household appliance by gestures as in a theremin, for example, making an input with the gesture of one hand and making another input with another gesture of the other hand. It may also be provided that the size and/or the distance of the 3-D object perceived by the user is adjusted according to an input of the user or a status of the household appliance (e.g. the speed of a blender, the measured weight on a scale). This also facilitates the operation of the household appliance.

It can be provided that the 3-D user object is displayed together with further 3-D objects in the image information in such a way that the user is given the impression that he is manipulating the 3-D object with the gesture. For example, the size also offers the advantage that the user can operate the household appliance particularly easily.

A similar advantage is achieved by the detection of a voice input of the user, whereby also in this case the user does not have to touch the position the unit or the household appliance with his hands in order to control the household appliance, which simplifies the use of the household appliance as a whole. By carrying out a household activity, which can in particular be carried out partially automatically, the advantage that the use of the household appliance is particularly simple for the user is achieved in particular if the control is carried out via a gesture or via a voice input.

Furthermore, in a method according to the invention, it can advantageously be provided that the household appliance is designed/configured as described herein. Thus, the method according to the invention can be carried out on the household appliance according to the invention, in particular the kitchen appliance according to the invention for preparing food.

Further advantages, features and details of the invention will be apparent from the following description, in which embodiments of the invention are described in detail with reference to the drawings. In this connection, the features mentioned in the claims and in the description may each be essential to the invention individually or in any combination. It schematically shows:

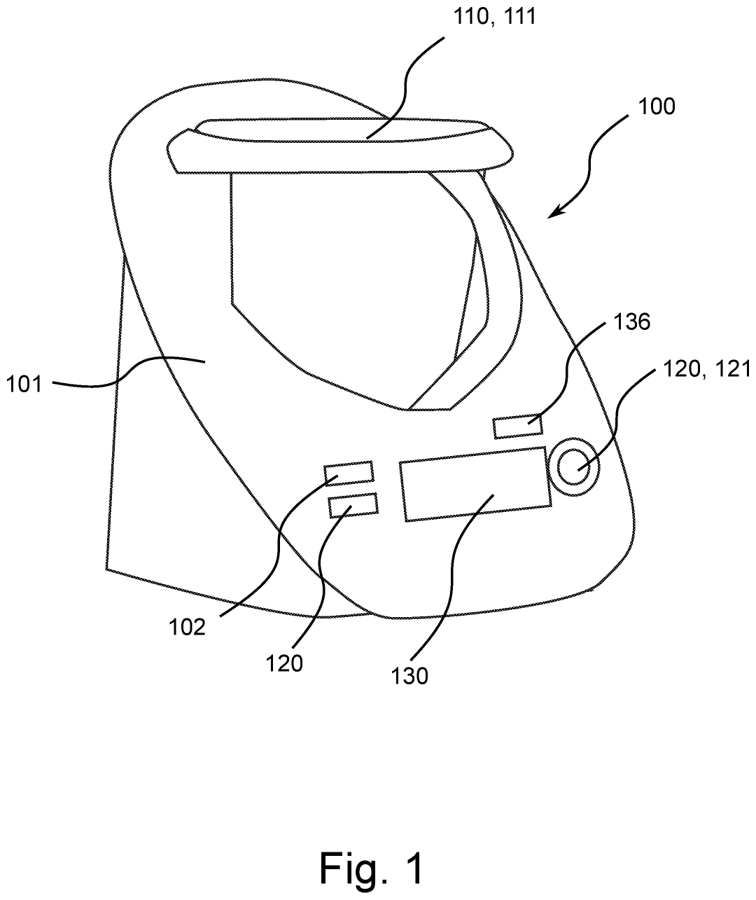

FIG. 1 shows a household appliance according to the invention, which is designed/configured as a kitchen appliance,

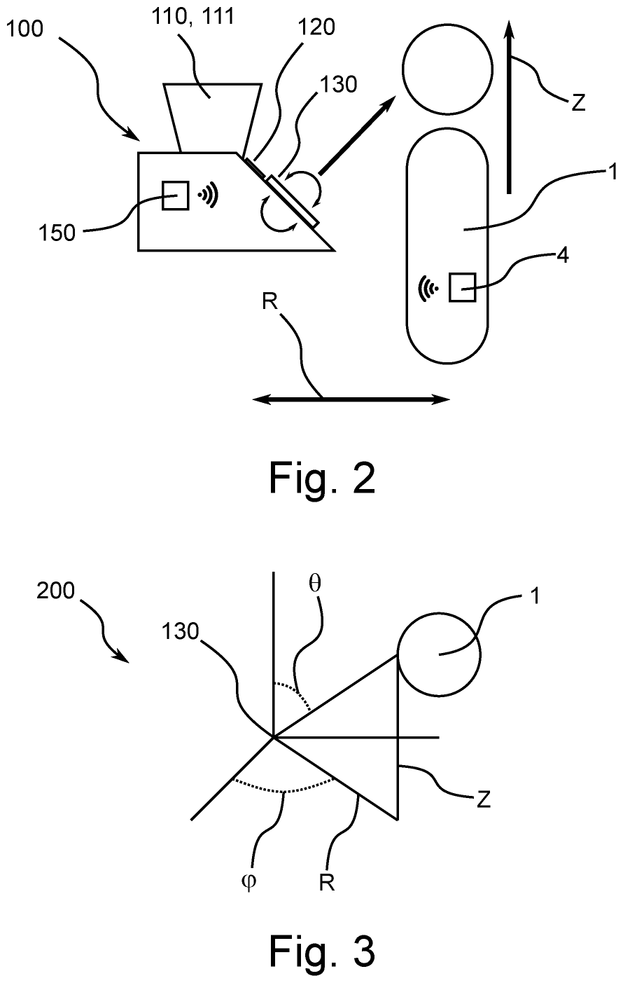

FIG. 2 a side view of a household appliance according to the invention with a user,

FIG. 3 a coordinate system showing a display of a household appliance according to the invention and a head of a user,

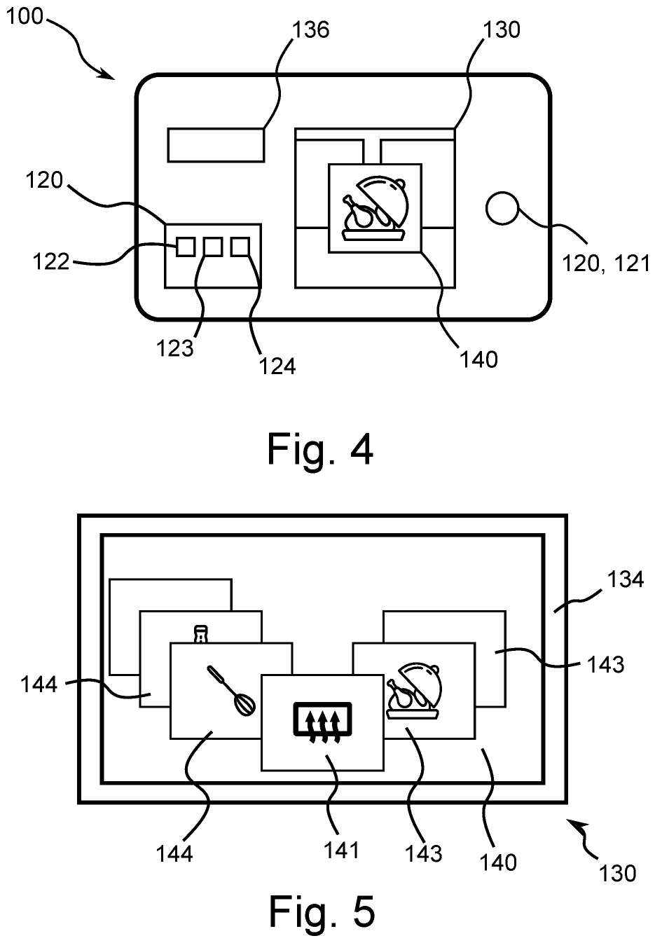

FIG. 4 a part of a household appliance according to the invention,

FIG. 5 display of a household appliance according to the invention,

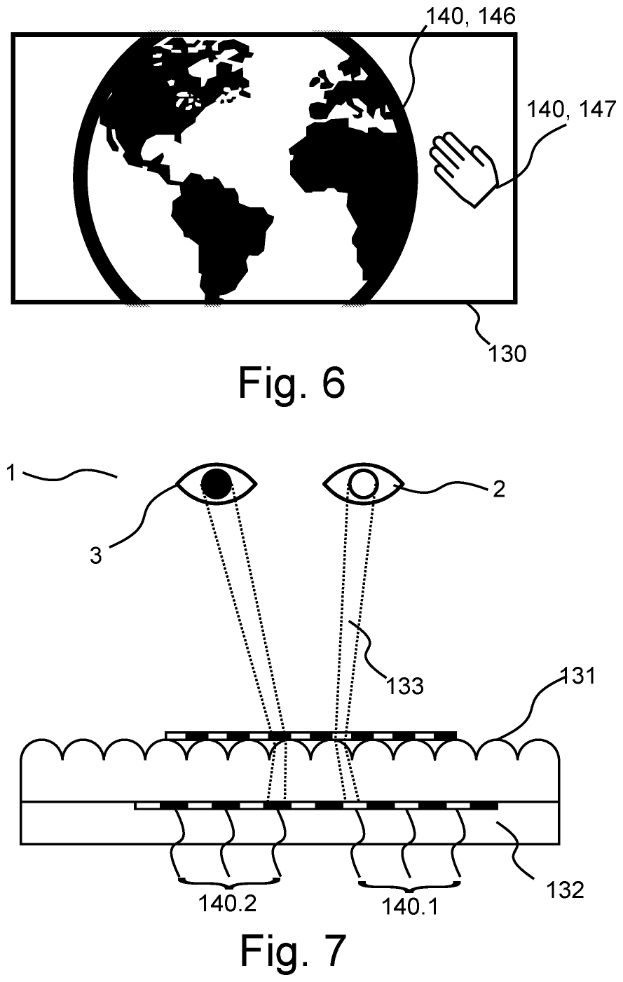

FIG. 6 an example of image information of a household appliance according to the invention,

FIG. 7 an embodiment of a display comprising a lens array,

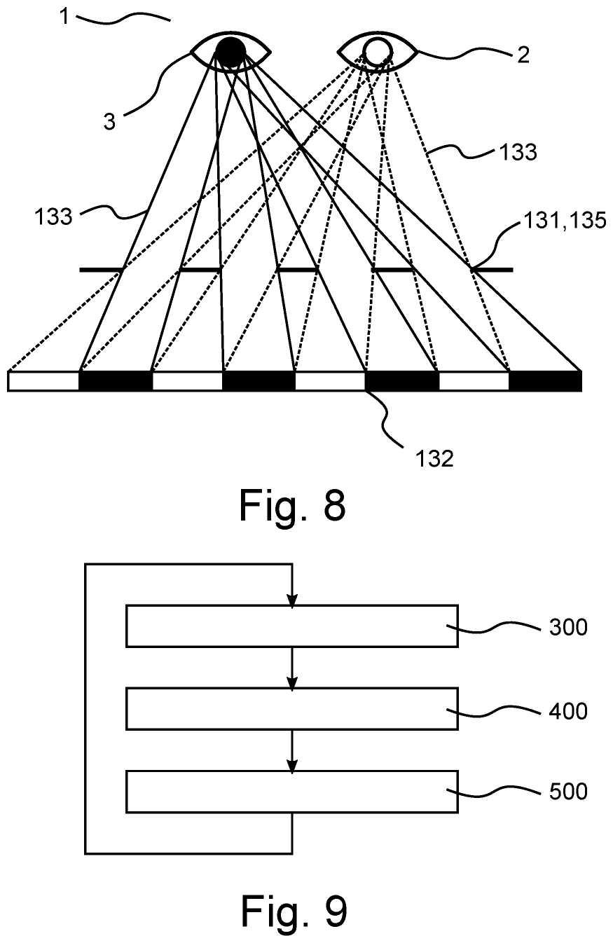

FIG. 8 an embodiment of a display comprising a barrier mask, and

FIG. 9 a method of operating a household appliance according to the invention.

In the following description of some embodiments of the invention, the identical reference signs are used for the same technical features even in different embodiments.

FIG. 1 shows a household appliance 100 according to the invention, which is designed/configured as a kitchen appliance 100 for preparing food. The household appliance 100 has a processing device 110, in particular a mixing vessel 111, for at least partially automatically carrying out a household activity. The household activity may in particular be a processing of ingredients. The processing device 110 is thereby controlled by a control unit 102. Also provided on the household appliance 100 is a positioning device 120, which is used for detecting a position information 200 of a user 1 (not shown here) operating the household appliance 100. The positioning device 120 may, for example, have sensors (shown schematically on the left of the display 130 in FIG. 1) and/or be designed/configured as a manually operable input unit 121, in particular as a rotary knob 121 (shown schematically on the right of the display 130 in FIG. 1). The position device 120 transmits the detected position information 200 to a control unit 102. Also shown in FIG. 1 is a display 130, which is designed/configured to reproduce image information 140 determined by the control unit 102. The image information 140 reproduced by the display 130 generates an impression of depth for the user 1 (not shown here) and is dependent at least on the position information 200 of the user 1.

Also shown in FIG. 1 is that, in addition to the display 130, a further display 136 is provided, which may in particular be designed/configured as a 2-D display 136. With respect to the display 130, it can be provided that it has a 2-D mode and a 3-D mode, wherein in particular the display 130 can switch between a 2-D mode and a 3-D mode on the basis of the position information 200.

Furthermore, it can be seen from FIG. 1 that the household appliance 100 can be of multi-part design/configuration, and has at least one main body 101 which can be connected to a mains power supply and/or on which the processing device 110 is provided, wherein in particular the display 130 can be detachably attached to the main body 101 or the display 130 is integrally connected to the main body 101.

FIG. 2 shows a side view of the household appliance 100 according to the invention, wherein the household appliance is designed/configured as a kitchen appliance 100 and comprises a processing device 110 with a stirring vessel 111. Also shown in FIG. 2 is a user 1 carrying a mobile identification transmitter 4. According to the embodiment shown, this mobile identification transmitter 4 can cooperate with a user identification device 150 provided on the household appliance. The user identification device 150 is adapted to identify the user 1, which may in particular be adapted to communicate with a mobile identification transmitter 4 of the user 1. In this context, the mobile identification transmitter 4 may in particular be designed/configured as a mobile radio telephone and or RFID tag 4. The communication between the mobile identification transmitter 4 and the user identification device 150 can in particular be wireless, preferably via Bluetooth, Bluetooth low energy and/or WLAN.

Furthermore, it is shown in FIG. 2 that the display 130 has an axis of rotation about which the display 130 can be rotated in relation to the user 1, in particular based on the position information 200. This makes it possible for the depth impression to be generated for the user even if the latter changes his position, in particular the height, which is denoted by Z in FIG. 2. In particular, it may be provided that the display 130 has a motor which automatically moves the display 130 in such a way, which is shown in FIG. 2 as an arrow starting from the display 130, is always directed towards the face of the user 1. This can ensure that the image information 140 reproduced by display 130 can always create an impression of depth for user 1.

According to FIG. 2, the user 1 is located at a distance R from the household appliance 100 and has a height Z. It may be provided that the user manually communicates his distance R and/or his size Z to the positioning device 120 by an input. Alternatively, or in addition, it may also be provided that the positioning device 120 automatically determines both the distance R and the size Z of the user.

It may also be provided that the display 130 is rotatable about two axes. A gimbal mounting of the display 130 may also be provided, which offers the advantage that the display 130 can be optimally aligned in a space for the user 1 independently of the orientation of the household appliance 100.

FIG. 3 shows the position of a user 1 in relation to the display 130. This essentially represents the position information 200. Thus, the user 1 can be at a distance R and an azimuth angle φ and a height Z to the display 130, in particular to a center of the display 130 or a normal to the center of the display 130. Through this, the position, in particular of a head, of the user 1 can be unambiguously determined as position information 200. Furthermore, the normal can correspond to a polar angle θ.

FIG. 4 shows a household appliance 100 according to the invention, in which a display 130 presents image information 400. Furthermore, it is shown in FIG. 4 that the positioning device 120 may further comprise a camera 122, which is in particular adapted to detect the user 1, a gesture sensor 123, which is adapted to detect a gesture of the user 1 for controlling the household appliance 100, and a sound transducer 124, which is adapted to detect a voice input of the user 1 for controlling the household appliance 100, wherein the sound transducer 124 is in particular configured as a microphone. Furthermore, in the embodiment example according to FIG. 4, it is provided that the positioning device 120 further comprises a manually operable input unit 121 in the form of a rotary knob 121. Thereby, the manually operable input unit 121 can be designed/configured to control at least the processing device 110 by an input of the user 1 (both not shown here).

In this regard, the gesture sensor 123 may comprise at least one of the following components: A camera, a radar sensor, a lidar sensor, a capacitive sensor, or an ultrasonic sensor.

FIG. 5 shows a display 130 that displays image information 140. Thereby, according to FIG. 5, the display 130 has a housing 134, wherein in particular the housing 134 has a frame. On this housing 134, in particular the positioning device 120 can be provided, and in particular this can be integrated. Also shown in FIG. 5 is that the image information 140 may comprise image information 141 which is specific to the operation of the household appliance. In the example shown, the specific image information 141 displayed is an icon for a heater, which may be active, for example, in a kitchen appliance at the time of display. Also shown according to FIG. 5, the image information 140 may also comprise previous image information 144 and/or subsequent image information 143, wherein in particular at least two of the image information 141, 143, 144 differ in a display depth for the user 1 (not shown here). In the example shown in FIG. 5, the specific image information 141 is shown spatially in front of a previous image information 140 and a subsequent image information 143. In other words, the image information 140 in FIG. 5 is shown as a collection of spatially separated cuboidal information blocks 141, 143, 144, which are distributed in particular as a CD cover within the image information 140. In particular, it may be provided that a user can spatially move the cuboidal information blocks 141, 143, 144 via a gesture which can be recognized by the gesture control 123. This simplifies the use of the household appliance 100, since the user in particular does not have to touch the household appliance 100, and can nevertheless also work through complicated sequences of steps/stages to be performed.

FIG. 6 discloses another variant of an image information 140 represented by the display 130, in which a 3-D object 146 is represented. In addition to the 3-D object 146, a 3-D user object 147 is also shown, which can be moved in the spatial representation by the user 1 in particular by a gesture recognized by the positioning device 120 or the gesture sensor 123. It may be provided that the user 1 can enter a recipe selection by the recognized gesture on the 3-D object 146. In particular, it may be provided that a hand of the user is rendered as a 3-D user object 147 in the image information 140. This offers the advantage that the user can find the gesture taking place in the three-dimensional space, also spatially represented, in the image information 140, so that the use of the household appliance 100 is simplified. It may also be provided that the 3-D user object 147 is represented together with further 3-D objects 146 in the image information 140 in such a way that the user 1 is given the impression that he is manipulating the 3-D object 146 with the gesture. This also offers the advantage that the user 1 can operate the household appliance 100 particularly easily.

FIG. 7 shows an example embodiment of the display 130 in which the display has an optical component 131. According to the example in FIG. 7, this is formed as a lens array 131. Furthermore, as shown in FIG. 7, the display 130 may further comprise a light unit 132 which, starting from the eye 2, 3 of the viewer 1, is located behind the lens array 131 and reproduces the image information 140 by emitting photons (shown here as dashed lines in the form of light beams 133). According to the representation in FIG. 7, image information 140.1 intended for the left eye 2 is deflected by the lens array 131 in such a way that these light beams 133 strike only the left eye 2, and image information 140.2 intended for the right eye 3 is deflected by the lens array 131 in such a way that the light beams 133 strike only the right eye 3. Accordingly, the lens array 131 is suitable for blocking the image information 140.1 intended for the left eye 2 for the right eye 3 and for blocking the image information 140.2 intended for the right eye 3 for the left eye 2.

FIG. 8 shows an alternative embodiment of the display 130, in which the optical component 130 is designed/configured as a barrier mask 135. The barrier mask 135 also serves to block image information 140.1 intended for the left eye 2 from reaching the right eye 3, and to block image information 140.2 intended for the right eye 3 from reaching the left eye 2. In contrast to the lens array 131, in which the light rays 133 are deflected by refraction, the barrier mask 135 blocks the light rays 133 by absorption due to the geometric arrangement of the masks.

FIG. 9 illustrates the method according to the invention for operating a household appliance 100, in particular a kitchen appliance 100 for preparing food, wherein the detection 300 of position information 200 of a user 1 by a positioning device 120, as well as the reproduction 400 of image information 140 by a display 130, which is designed/configured to generate an impression of depth at the user 1, is shown. In this case, the image information 140 is dependent on at least the position information 200. Furthermore, FIG. 9 also shows the reproduction 500 of an image information 141, which is specific to the operation of the household appliance, by a display 130, wherein, in addition to the specific image information 141, a previous image information 144 and/or a subsequent image information 143 are shown, wherein, in particular, at least two of the image information 141, 143, 144 differ in a display depth for the user 1.

The foregoing explanation of embodiments describes the present invention exclusively in the context of examples. Of course, individual features of the embodiments can be freely combined with each other, if technically feasible, without affecting the scope of the present invention.

### LIST OF REFERENCE SIGNS

1 User
2 Left eye
3 Right eye
4 Identification device
100 Household appliance, especially kitchen appliance
101 Main body
102 Control unit
110 Processing device
111 Stirring vessel
120 Positioning device
121 Input unit, especially rotary knob
122 Camera
123 Gesture sensor
124 Sound transducer
130 Display, especially 3D display
131 Optical unit, especially lens array
132 Lighting unit
133 Light rays
134 Display housing
135 Barrier-mask
136 Additional display
140 Image information
140.1 Image information of the left eye
140.2 Image information of the right eye
141 Image information, especially specific to the household appliance
143 Image information, especially sequence information
144 Image information, especially sequence information
146 3D object
147 3D user object
150 User identification device
200 Position information
300 Detection
400, 500 Reproduction
R Distance, especially of the user, to the display
Z Height, especially of the user,
φ Azimuth angle
θ Polar angle

1. A household appliance, for preparing food, comprising:
a processing device for at least partially automatically carrying out a household activity the processing device being controlled by a control unit,
a position device for detecting position information of a user operating the household appliance, wherein the position information is transmitted to the control unit,
a display adapted to display image information determined by the control unit, wherein
the image information reproduced by the display generates an impression of depth at the user and is dependent on at least the position information of the user.

2. The household appliance according to claim 1,
wherein
the display comprises at least an autostereoscopic display or virtual reality glasses or a holographic display.

3. The household appliance according to claim 1,
wherein
the display comprises at least one of the following components: an optical component, a barrier mask, or a light unit.

4. The household appliance according to claim 1,
wherein
the image information reproduced by the display generates an impression of depth at the user at a defined image position in relation to the display, the defined image position corresponding to the position information of the user, when a user moves in relation to the display.

5. The household appliance according to claim 1,
wherein
at least the positioning device is suitable for detecting position information from a plurality of users in each case or
that the display is adapted to reproduce a plurality of image information, each of which creates an impression of depth for a plurality of users.

6. The household appliance according to claim 1,
wherein
the display has a 2D mode and a 3D mode.

7. The household appliance according to claim 1,
wherein
at least a user identification device is further provided which is configured to identify the user or furthermore, a user identification device is provided which is configured to at least actively or passively identify the user.

8. The household appliance according to claim 1,
wherein
the display, has at least one axis of rotation, about which the display can be rotated in relation to the user.

9. The household appliance according to claim 1,
wherein
a further display is provided.

10. The household appliance according to claim 1,
wherein
the positioning device comprises at least one of the following components:
a manually operable input unit,
a camera
a gesture sensor adapted to detect a gesture of the user for controlling the household appliance, or
a sound transducer which is configured to detect a voice input of the user for controlling the household appliance.

11. The household appliance according to claim 10,
wherein
the gesture sensor comprises at least one of the following components:
a camera,
a radar sensor,
a lidar sensor,
a capacitive sensor or
an ultrasonic sensor.

12. The household appliance according to claim 1,
wherein
the household appliance is of multipart configuration and has at least one main body which can at least be connected to a mains power supply or on which the processing device is provided.

13. A method for operating a household appliance, comprising:
detection of position information of a user by a position device,
reproduction of image information by a display adapted to create an impression of depth in the user, wherein
the image information is dependent on at least the position information.

14. The method of operating a household appliance according to claim 13,
wherein
the method further comprises at least one of the following:
reproduction of image information specific to the operation of the household appliance by a display, wherein, in addition to the image information, at least previous image information or subsequent image information is displayed
initial recognition of a user by a user identification device, detection of a gesture of the user by at least a gesture sensor to control the household appliance, or detection of a voice input of the user to control the household appliance by a sound transducer,
performing a household activity.

15. The method of operating a household appliance according to claim 13,
wherein
the household appliance comprises
a processing device for at least partially automatically carrying out a household activity the processing device being controlled by a control unit,
a position device for detecting position information of a user operating the household appliance, wherein the position information is transmitted to the control unit,
a display adapted to display image information determined by the control unit, wherein
the image information reproduced by the display generates an impression of depth at the user and is dependent on at least the position information of the user.
